(19) United States
(12) Patent Application Publication
(10) Pub. No.: US 2011/0175256 A1
(43) Pub. Date: Jul. 21, 2011

(54) MOLD CARRIER FOR SUPPORTING A MOLD

(75) Inventors: Daryl P. Wernette, Johnstown, OH (US); Wayne J. Buoni, New Albany, OH (US); Jonathan A. Verhoff, Reynoldsburg, OH (US)

(73) Assignee: Boral Stone Products LLC.

(21) Appl. No.: 13/006,685

(22) Filed: Jan. 14, 2011

Related U.S. Application Data
(60) Provisional application No. 61/295,896, filed on Jan. 18, 2010.

(51) Int. Cl. B29C 33/50; B28B 7/06

(52) U.S. Cl. 264/316; 249/127

(57) ABSTRACT

An apparatus configured to form masonry siding products is provided. The apparatus includes a mold having a mold bottom and a plurality of mold walls defining a mold cavity. A mold carrier is configured to support the mold bottom and the mold walls. The mold carrier has a first member that extends upwardly from a base member and a second member that extends upwardly from the base member. The first member forms an internal first angle of about 90° with the base member. The second member forms an internal second angle in a range of from about 100° to about 110° with the base member. The internal first angle formed by the first member and the base member and the internal second angle formed by the second member and the base member are configured to allow for easy removal of the mold from the mold carrier.

### CROSS REFERENCE TO RELATED APPLICATIONS

This application claims the benefit of pending U.S. Provisional Patent Application No. 61/295,896, filed Jan. 18, 2010, the disclosure of which is incorporated herein by reference.

### BACKGROUND

Siding can be an outer covering of a building or structure. Siding is configured to repel weather elements and protect the building or structure from the effects of weather. Additionally, siding can present a desired aesthetic appearance to the building or structure.

Siding can take many forms including the non-limiting examples of horizontal boards, vertical boards, shingles, panel materials or sheet materials. Siding can also be made of many different materials including wood, metal, polymers, masonry or composites.

Siding can be applied to various types of building structures. Some examples of building structures configured to support siding include wood or metal framework (studs) or framework covered by an intermediate layer of sheet material (sheathing). Siding can be applied to the various types of building structures with different methods including the non-limiting examples of nailing, construction adhesives or combinations thereof.

It would be advantageous if masonry siding products could be manufactured more efficiently

### SUMMARY

In accordance with embodiments of this invention there is provided an apparatus configured to form masonry siding products. The apparatus includes a mold having a mold bottom and a plurality of mold walls. The mold bottom and the mold walls define a mold cavity. A mold carrier is configured to support the mold bottom and the mold walls. The mold carrier has a first member that extends upwardly from a base member and a second member that extends upwardly from the base member. The first member forms an internal first angle of about 90° with the base member. The second member forms an internal second angle in a range of from about 100° to about 110° with the base member. The internal first angle formed by the first member and the base member and the internal second angle formed by the second member and the base member are configured to allow for easy removal of the mold from the mold carrier.

In accordance with embodiments of this invention there is also provided a method of forming simulated stone corner products. The method includes the steps of providing a mold having a flexible mold bottom and flexible mold walls, positioning the mold within a mold carrier configured to support the flexible mold bottom and flexible mold walls, the mold carrier having a first member extending upwardly from a base member and a second member extending upwardly from the base member, wherein the first member, base member and second member form a unitary structure, and wherein the flexible mold walls rely on the first and second members to define a mold cavity having a desired shape, filling the mold cavity with castable material, allowing the castable material to harden thereby forming a simulated stone corner product, removing the mold from the mold carrier and removing the simulated stone corner product from the mold by flexing the flexible mold walls.

Various advantages of this invention will become apparent to those skilled in the art from the following detailed description of the invention, when read in light of the accompanying drawings.

### BRIEF DESCRIPTION OF THE DRAWINGS

FIG. 1 is a perspective view of a masonry siding panel.

FIG. 2 is a side view, in elevation, of the masonry siding panel of FIG. 1, illustrated in an installed position.

FIG. 3 is a side view, in cross-section, of a mold assembly having a mold and a first embodiment of a mold carrier for manufacturing the masonry siding panel of FIG. 1.

FIG. 4 is a side view, in cross-section, of the mold assembly of FIG. 3.

FIG. 5 is a perspective view of the mold carrier of FIG. 3.

FIG. 6 is a perspective view of a pair of mold assemblies of FIG. 3 fastened to a mold assembly platform to form a production assembly.

FIG. 7 is a side view, in elevation, of a plurality of production assemblies of FIG. 6 shown in a stacked configuration.

FIG. 8 is a second embodiment of a mold carrier for manufacturing the masonry siding panel of FIG. 1.

FIG. 9 is a side view, in cross-section, of a second embodiment of a mold assembly having a mold and the mold carrier of FIG. 8.

FIG. 10 is a perspective view of a pair of mold assemblies of FIG. 8 fastened to a mold assembly platform to form a production assembly.

FIG. 11 is a side view, in cross-section, of another embodiment of a mold and mold carrier for producing a masonry siding panel.

FIG. 12 is a perspective view of a plurality of mold assemblies of FIG. 11 fastened to a mold assembly platform to form a production assembly.

### DETAILED DESCRIPTION OF VARIOUS EMBODIMENTS OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

The description and figures disclose mold carriers for use during the molding process of masonry siding products. The term “mold carrier”, as used herein, is defined to mean any structure configured to support a mold during a molding process. The term “masonry”, as used herein, is defined to mean any materials representing or simulating natural stonework or brickwork. Masonry siding products can be in the form of panels, corner pieces and trim pieces. Masonry siding products can be manufactured using a mold filled with castable material flowing from a source of castable material.

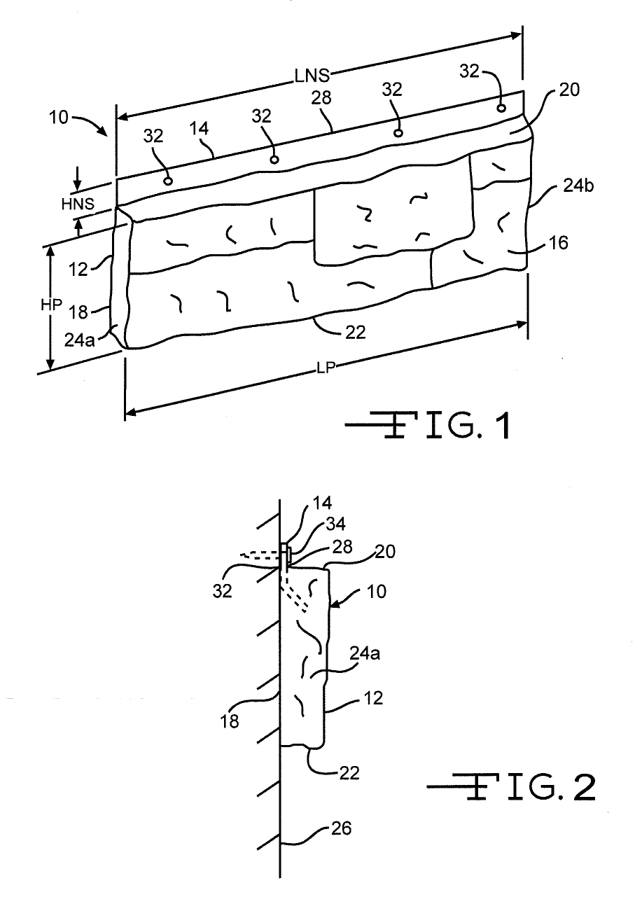

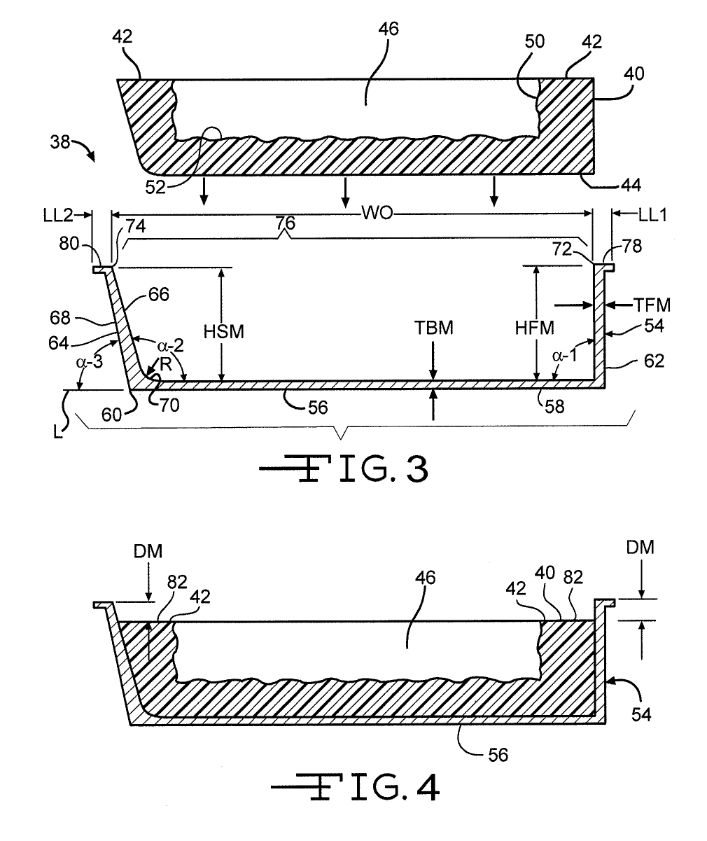

Referring now to FIGS. 1 and 2, one example of a masonry siding product is shown generally as 10. The masonry siding product 10 includes a panel 12 and a nailing strip 14. The panel 12 has a front face 16, back face 18, top edge 20, bottom edge 22 and opposing side edges 24a and 24b. As will be explained in more detail below, the panel 12 is cast from a mold filled with castable material. In the illustrated embodiment, the front face 16, top edge 20, bottom edge 22 and opposing side edges 24a and 24b have a textured surface. The term “textured surface”, as used herein, is defined to mean an imitation of the tactile quality of a represented object. In the illustrated embodiment, the front face 16, top edge 20, bottom edge 22 and opposing side edges 24a and 24b have a textured surface that simulates natural stone. Alternatively, the front face 16, top edge 20, bottom edge 22 and opposing side edges 24a and 24b can have textured surfaces that simulate other materials, such as the non-limiting example of brick.

Referring now to FIG. 1, the panel 12 has a length LP and a height HP. In the illustrated embodiment, the length LP of the panel 12 is in a range of from about 8.0 inches to about 36.0 inches and the height HP of the panel 12 is in a range of from about 4.0 inches to about 16.0 inches. In other embodiments, the length LP of the panel 12 can be less than about 8.0 inches or more than about 36.0 inches and the height HP of the panel 12 can be less than about 4.0 inches or more than about 16.0 inches. While the panel 12 illustrated in FIG. 1 is shown as having a generally rectangular shape, it should be appreciated that in other embodiments, the panel 12 can have other desired shapes, including the non-limiting example of an irregular shape.

Referring again to FIG. 1, the nail strip 14 includes an extension portion 28. The extension portion 28 of the nail strip 14 extends from the back face 18 of the panel 12 and is configured for attachment to a building structure 26 as shown in FIG. 2. Referring again to FIG. 1, the nail strip 14 can be made from any desired material, including the non-limiting example of metal.

The nail strip 14 can have any desired thickness including the non-limiting thickness of 20 gauge. The nail strip 14 can have any desired finish or coating including the non-limiting example of a rust preventative coating.

As shown in FIG. 1, the nail strip 14 has a length LNS and a height HNS. In the illustrated embodiment, the length LNS of the nail strip 14 is in a range of from about 8.0 inches to about 36.0 inches and the height HNS of the nail strip 14 is in a range of from about 0.5 inches to about 6.0 inches. In other embodiments, the length LNS of the nail strip 14 can be less than about 8.0 inches or more than about 36.0 inches and the height HNS of the nail strip 14 can be less than about 0.5 inches or more than about 6.0 inches. While the nail strip 14 illustrated in FIG. 1 is shown as a continuous structure, it should be appreciated that in other embodiments, the nail strip 14 can be other desired structures, including the non-limiting example of discontinuous segments.

Referring again to FIGS. 1 and 2, the extension portion 28 of the nail strip 14 has a plurality of apertures 32 spaced apart along the length LNS of the nail strip 14. The apertures 32 are configured for insertion of an anchoring member 34 as shown in FIG. 2. The anchoring member 34 is configured to attach the panel 12 to the building structure 26. In the illustrated embodiment, the anchoring member 34 is a nail. However, the anchoring member 34 can be other structures, devices or mechanisms configured to attach the panel 12 to the building structure 26, including the non-limiting example of a screw.

Referring now to FIG. 2, the building structure 26 can be any structure suitable for siding. In one embodiment, the building structure 26 can be an exterior sheathing configured to provide rigidity to the building structure 26 and further configured to provide a surface for the exterior siding 10. In the illustrated embodiment, the exterior sheathing is made of oriented strand board (OSB). In other embodiments, the exterior sheathing can be made of other materials, such as for example plywood, waferboard, rigid foam or fiberboard, sufficient to provide rigidity to the building structure 26 and provide a surface for the exterior siding. In still other embodiments, the building structure 26 can be any desired framework including framework made from metal and/or wood studs.

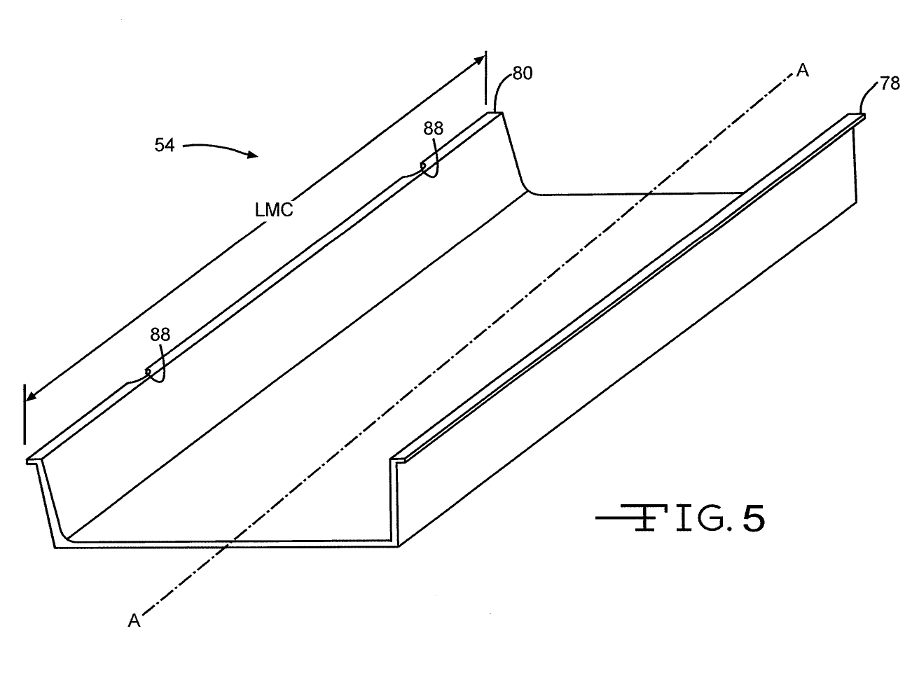

Referring now to FIG. 3, a mold assembly configured for manufacturing the masonry siding product 10 is illustrated generally as 38. The mold assembly 38 includes a mold 40 and a first embodiment of a mold carrier 54. The mold 40 is configured for insertion into the mold carrier 54 during the molding process. The mold carrier 54 will be discussed in more detail below.

The mold 40 includes opposing mold walls 42 and a mold bottom 44. The mold walls 42 and the mold bottom 44 cooperate to define a mold cavity 46. Generally, the mold cavity 46 is configured to be filled with a castable material (not shown). After the mold cavity 46 is filled with the castable material, the castable material is allowed to cure thereby forming a masonry siding product 10, as in, for example FIG. 1.

Referring again to FIG. 3, the mold walls 42 and the mold bottom 44 are configured to flex when the masonry siding product is removed from the mold 40. The mold walls 42 and the mold bottom 44 can be made from one or more layers of a suitable flexible material. In the illustrated embodiment, the mold walls 42 and the mold bottom 44 are made of a urethane-based rubber material. In other embodiments, the mold walls 42 and the mold bottom 44 can be made from one or more layers of other flexible materials or combinations of flexible materials, such as the non-limiting examples of curable elastomeric, latex or silicone rubber. Optionally, the mold walls 42 and the mold bottom 44 can include one or more reinforcing materials (not shown). The reinforcing materials can be added to, or encapsulated within, the mold walls 42 and the mold bottom 44. The reinforcing materials can be configured to reinforce the mold walls 42 and the mold bottom 44, yet allowing the mold walls 42 and the mold bottom 44 to still retain the desired flexibility. In certain embodiments, the reinforcing material can comprise a paste-like material, comprising, for example, a latex material, ground up rubber tires, sawdust, and MgO composition.

Referring again to FIG. 3, the mold walls 42 have a mold wall interior surface 50. Similarly, the mold bottom 44 has a mold bottom interior surface 52. The mold wall interior surface 50 and the mold bottom interior surface 52 have a textured surface that simulates natural stone. Alternatively, the mold wall interior surface 50 and the mold bottom interior surface 52 can have textured surfaces that simulate other materials, such as the non-limiting example of brick.

Referring again to FIG. 3, the mold 40 is configured for insertion into the mold carrier 54 during the molding process. The mold carrier 54 includes a base member 56 having a first end 58 and a second end 60. The base member 56 has a thickness TBM. In the illustrated embodiment, the thickness TBM of the base member 56 is in a range of from about 0.10 inches to about 0.30 inches. Alternatively, the thickness TBM of the base member 56 can be less than about 0.10 inches or more than about 0.30 inches.

As shown in FIG. 3, a first member 62 extends upwardly from the first end 58 of the mold carrier 54 and a second member 64 extends upwardly from the second end 60 of the mold carrier 54. The first member 62 of the mold carrier 54 forms a first angle α-1 with the base member 56. In the illustrated embodiment, the first angle α-1 is approximately 90°. In other embodiments, the first angle α-1 can be more than about 90°. The first member 62 has a thickness TFM. In the illustrated embodiment, the thickness TFM of the first member 62 is in a range of from about 0.10 inches to about 0.30 inches. Alternatively, the thickness TFM of the first member 62 can be less than about 0.10 inches or more than about 0.30 inches.

The second member 64 has an interior face 66 and an exterior face 68. The interior face 66 of the second member 64 forms a second angle α-2 with the base member 56. In the illustrated embodiment, the second angle α-2 is approximately 105°. In other embodiments, the second angle α-2 can be more or less than about 105°. Similarly, the exterior face 68 of the second member 64 forms a third angle α-3 with a substantially horizontal line L extending from the base member 56. In the illustrated embodiment, the third angle α-3 is approximately 78°. In other embodiments, the third angle α-3 can be more or less than about 78°.

Referring again to FIG. 3, an interior intersection 70 of the interior face 66 of the second member 64 and the base member 56 forms an arcuate cross-sectional shape. In the illustrated embodiment, the intersection 70 has a radius R in a range of from about 0.10 inches to about 0.50 inches. In other embodiments, the intersection 70 can have a radius R less than about 0.10 inches or more than about 0.50 inches.

Referring again to FIG. 3, the first member 62 has a height HFM and the second member 64 has a height HSM. In the illustrated embodiment, the heights HFM and HSM are in a range of about 2.0 inches to about 3.0 inches. Alternatively, the heights HFM and HSM can be more than about 2.0 inches or less than about 3.0 inches. While the heights HFM and HSM are illustrated in FIG. 3 as being the same, it should be appreciated that in other embodiments, the heights HFM and HSM can be different from each other.

Referring again to FIG. 3, the first member 62 has an upper edge 72 and the second member 64 has an upper edge 74. An opening 76 is formed between the upper edge 72 of the first member 62 and the upper edge 74 of the second member 64. The opening 76 has a width WO. In the illustrated embodiment, the width WO of the opening 76 is in a range of from about 10.0 inches to about 12.0 inches. In other embodiments, the width WO of the opening 76 can be less than about 10.0 inches or more than about 12.0 inches.

Generally, as shown in FIG. 3, the base member 56, substantially vertical first member 62 and the angled second member 64 cooperate to form an internal contour of the mold carrier 54. The internal contour of the mold carrier 54 substantially coincides with an external contour of the mold 40.

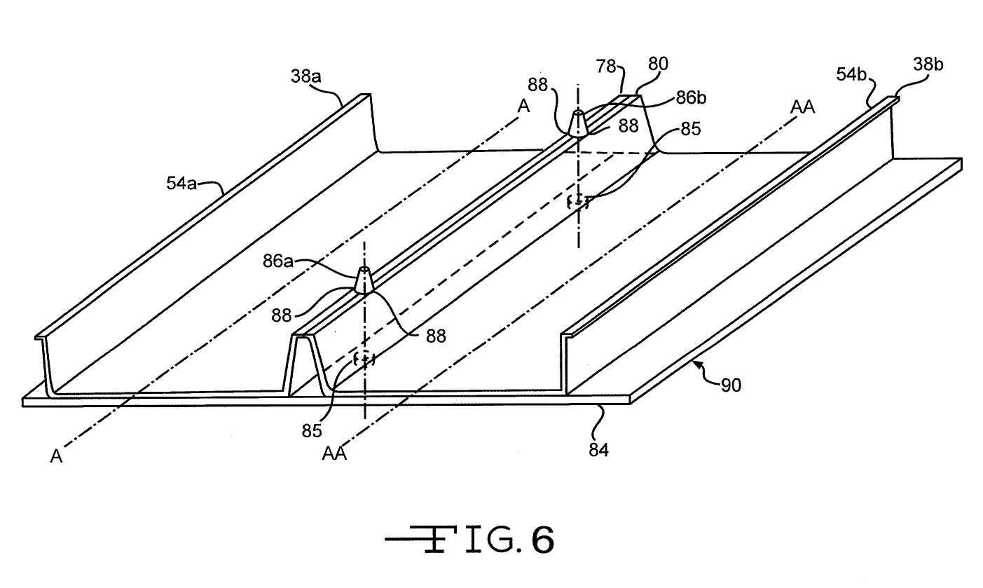

As discussed above, the mold 40 is inserted into a mold carrier 54 during the molding process. The resulting assembly of the mold 40 and the mold carrier 54 is illustrated in FIG. 4.

Referring again to FIG. 3, the first member 62 has a lip 78 extending in a substantially horizontal direction away from the upper edge 72. Similarly, the second member 64 has a lip 80 extending in substantially horizontal direction away from the upper edge 74. The lips, 78 and 80, are configured for lifting and handling of the mold assembly 38 during the molding process. The lip 78 has a length LL1. In the illustrated embodiment, the length LL1 of the lip 78 is in a range of from about 0.25 inches to about 0.50 inches. In other embodiments, the length LL1 of the lip 78 can be less than about 0.25 inches or more than about 0.50 inches. Similarly, the lip 80 has a length LL2. In the illustrated embodiment, the length LL2 of the lip 80 is in a range of from about 0.25 inches to about 0.50 inches. In other embodiments, the length LL2 of the lip 80 can be less than about 0.25 inches or more than about 0.50 inches. While the embodiment illustrated in FIG. 3 illustrates the lengths LL1 and LL2 of the lips, 78 and 80, as being the same, it should be appreciated that in other embodiments, the lengths LL1 and LL2 can be different from each other.

Referring again to the embodiment illustrated in FIG. 3, the mold carrier 54 is formed from an extrusion process, thereby resulting in a unitary structure. The term “extrusion process”, as used herein, is defined to mean the forming of a member with a desired cross section by forcing material or materials through a forming die. The term “unitary”, as used herein, is defined to mean being of a single element as opposed to being assembled from distinct elements. The mold carrier 54 is made from an extrusion compatible material. In one embodiment, the mold carrier 54 is made from aluminum. However, the mold carrier 54 can be made from other extrusion compatible materials, including the non-limiting example of bronze or plastic. The process of forming a mold carrier 54 includes extrusion of a mold carrier blank (not shown). The mold carrier blank is then cut into mold carriers 54 having any desired lengths.

Referring now to FIG. 4, the mold walls 42 have an upper surface 82. The upper surface 82 of the mold walls 42 forms a distance DM with the upper surface of the lips 78 and 80. In the illustrated embodiment, the distance DM is in a range of from about 0.10 inches to about 0.40 inches. However, in other embodiments, the DM can be less than about 0.10 inches or more than about 0.40 inches.

Referring now to FIG. 5, the mold carrier 54 is illustrated. The mold carrier 54 has a length LMC. The length LMC is configured to support a mold having a desired mold length. In the illustrated embodiment, the length LMC is in a range of from about 10.0 inches to about 80.0 inches. In other embodiments, the length LMC can be less than about 10.0 inches or more than about 80.0 inches. The mold carrier 54 has a longitudinal axis A and a plurality of apertures 88 located on lip 80. The apertures 88 will be discussed in more detail below.

While the embodiment of the mold carrier 54 illustrated in FIG. 5 is shown as being open ended, that is without ends, it should be appreciated that other embodiments of the mold carrier 54 can include ends.

Referring now to FIG. 6, the process for making masonry siding products 10 will now be described. In an initial step, a pair of mold assemblies 38a and 38b (for purposes of clarity the molds 40 are not shown), are positioned on a mold assembly platform 84. The mold assembly platform 84 is configured to support the mold assemblies 38a and 38b during the molding process. In the illustrated embodiment, the mold assembly platform 84 is plywood. However, in other embodiments, the mold assembly platform 84 can be other materials, including the non-limiting example of aluminum, sufficient to support the mold assemblies 38a and 38b during the molding process. The mold assembly platform 84 includes a plurality of apertures 85. The apertures 85 will be discussed in more detail below. Attaching the mold assemblies 38a and 38b to the mold assembly platform 84 forms production assembly 90.

The mold assemblies 38a and 38b are positioned on the mold assembly platform 84 such that the lips 80 of the mold carriers 54a and 54b align with each other. In these positions, the longitudinal axis A of mold carrier 54a and the longitudinal axis AA of mold carrier 54b are substantially parallel to each other. The mold carriers 38a and 38b can be fastened to the mold assembly platform in any desired manner, including the non-limiting example of screws or clamps. While the embodiment illustrated in FIG. 6 shows a quantity of two mold assemblies, 38a and 38b, fastened to the mold assembly carrier 84, it should be appreciated that in other embodiments, a quantity of more than two mold assemblies can be positioned on and fastened to the mold assembly carrier 84 such that the lip 80 of a mold carrier 54 aligns with the lip 80 of a subsequent mold carrier 54.

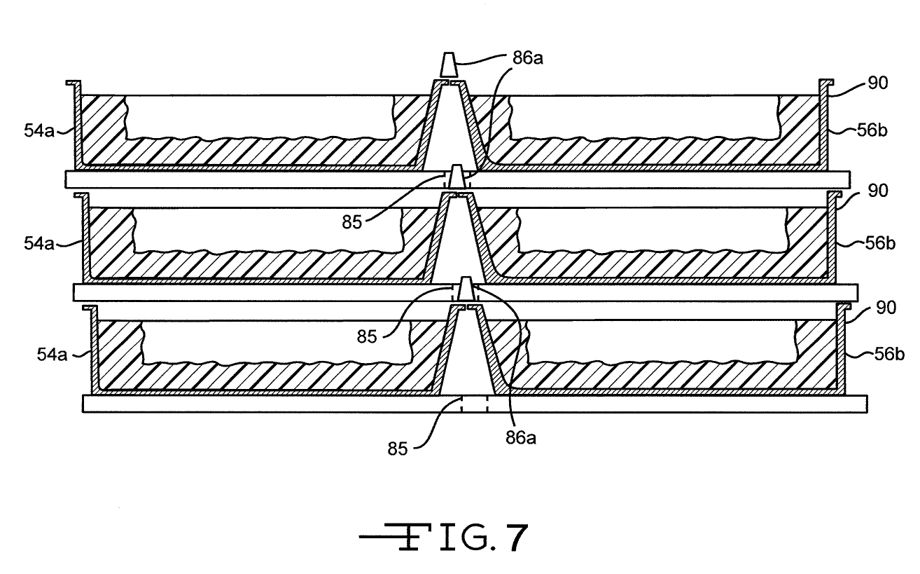

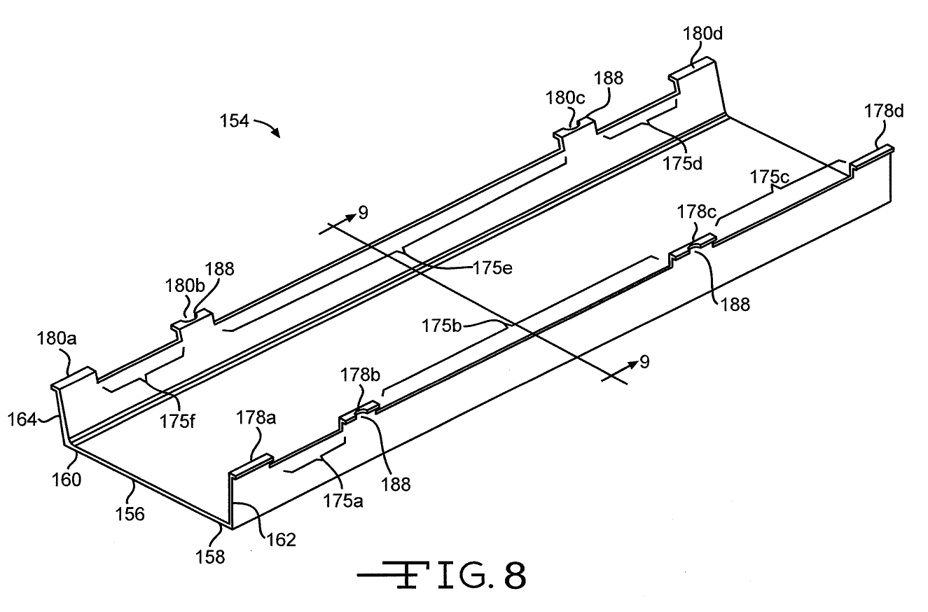

Optionally, following the positioning and fastening of the mold assemblies 38a and 38b to the mold assembly platform 84, locating pins 86a and 86b are fastened to the intersection of the lips 80 of the mold carriers 54a and 54b. The locating pins, 86a and 86b, are configured to align in a vertical direction with the apertures 85 in the mold assembly platform 84 such that subsequent mold production assemblies 90 can be nested or stacked as shown in FIG. 7, when the production assemblies 90 are not in production.

In the embodiment illustrated in FIG. 6, the locating pins 86a and 86b have a frusto-conical cross-sectional shape. Alternatively, the locating pins 86a and 86b can have other cross-sectional shapes. The locating pins 86a and 86b are fastened to the lips 80 of the mold carriers 54a and 54b by fasteners (not shown) extending through the apertures 88 in the lips. In the illustrated embodiment, the fasteners are bolts. In other embodiments, the fasteners can be other structures or mechanisms, such as for example, clamps sufficient to fasten the locating pins 86a and 86b to the lips 80 of the mold carriers 54a and 54b.

Referring again to FIG. 4, in a next step a castable material (not shown) is deposited in the mold cavity 46 by any desired structure, device or mechanism, such as the non-limiting example of a hopper (not shown). The castable material fills the mold cavity 46 to a desired level. The castable material is allowed to substantially cure. After curing, the mold 40 is removed from the mold carrier 54 and the formed masonry siding product 10 is removed from the mold 40.

The mold carrier 54 as described above and illustrated in FIGS. 1-7 advantageously provides many benefits. However, in some instances, not all of the advantages will be realized. First, the support provided by the first and second members, 62 and 64, of the mold carrier 54 allows the mold 40 to have thinner mold walls 42. Having thinner mold walls 42 allows less mold material to be used, thereby reducing the cost of a mold 40. Second, the support provided by the first and second members, 62 and 64, of the mold carrier 54 allows the mold 40 to have more flexible mold walls 42. The increased flexibility of the mold walls 42 allows the formed masonry siding product to be removed more quickly and easier from the mold 40, thereby reducing manufacturing cost and time. While not shown in FIG. 4, it should be appreciated that in some embodiments, the mold walls 42 can be so flexible as to rely on the shape of the first and second members, 62 and 64, of the mold carrier 54 to define the shape of the cavity 46. In other words, without the support of the first and second members, 62 and 64, the mold walls 42 would tend to collapse or otherwise deform. Third, using an extrusion compatible material, such as for example aluminum, for the mold carrier 54 provides for reduced deterioration of the mold carrier 54 due to corrosion and moisture of the mold carrier 54 through extended manufacturing use, thereby improving accuracy of the mold carrier 54 from one manufacturing sequence to another. Previously, mold carriers made of wood or metal would deteriorate due to moisture and use, resulting in undesirable variability in the dimensions of the mold carriers. In addition, the longevity of the mold carriers 54 is improved. Fourth, as the masonry siding products 10 are installed in a mating arrangement with other masonry siding products 10, the masonry siding products 10 have a need for dimensional accuracy from one panel another panel. The extruded formation of the mold carrier 54 provides for repeatable dimensional consistency and accuracy of the formed masonry siding products 10. Lastly, the using an extrusion compatible material, such as for example aluminum, for the mold carrier 54 provides for a lightweight structure, thereby allowing stacking of the mold carriers 54 on top of each other, as shown in FIG. 7, without the need for shelving or special stacking structures.

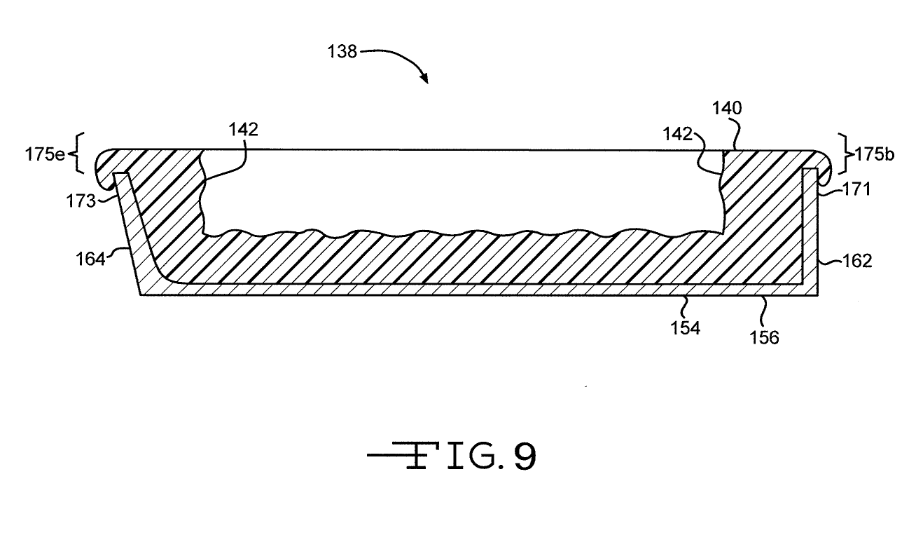

Another embodiment of a mold carrier 154 is shown in FIG. 8. The mold carrier 154 is configured to include an inserted mold (not shown) during the molding process. The mold carrier 154 includes a base member 156 having a first end 158 and a second end 160. A first member 162 extends upwardly from the first end 158 of the mold carrier 154 and a second member 164 extends upwardly from the second end 160 of the mold carrier 154. In the illustrated embodiment, the base member 156, first member 162 and second member 164 are the same as, or similar to, the base member 56, first member 62 and second member 64 discussed above and illustrated in FIG. 3. In other embodiments, the base member 156, first member 162 and second member 164 can be different from the base member 56, first member 62 and second member 64.

Referring again to FIG. 8, the first member 162 has a plurality of discontinuous lip segments, 178a, 178b, 178c and 178d, extending in a substantially horizontal direction away from the first member 162. Similarly, the second member 164 has a plurality of discontinuous lip segments, 180a, 180b, 180c and 180d, extending in substantially horizontal direction away from the second member 164. In the illustrated embodiment, the lip segments, 178a, 178b, 178c, 178d, 180a, 180b, 180c and 180d are the same as, or similar to, the lips 78 and 80 discussed above and illustrated in FIG. 3 with the exception that the lip segments, 178a, 178b, 178c, 178d, 180a, 180b, 180c and 180d are discontinuous The term “discontinuous”, as used herein, is defined to mean extending less than the full length of the mold carrier 154. The lip segments 178a, 178b, 178c, 178d, 180a, 180b, 180c and 180d can have any desired length.

As shown in FIG. 8, a notch 175a is formed between the discontinuous lip segments 178a and 178b. Similarly, a notch 175b is formed between the discontinuous lip segments 178b and 178c. Notches 175c, 175d, 175e and 175f are formed in similar manners between discontinuous lip segments 178c and 178d, discontinuous lip segments 180d and 180c, discontinuous lip segments 180c and 180b, and discontinuous lip segments 180b and 180a, respectively.

Referring now to FIG. 9, the mold carrier 154 having base member 156, first member 162, second member 164 and mold 140 is illustrated. The first member 162 has an upper portion 171 that truncates at notch 175b. Similarly, the second member 164 has an upper portion 173 that truncates at notch 175e. It can be seen that the notches 175b and 175e allow the mold 140 to “fold” over the upper portions 171 and 173. By folding over the upper portions 171 and 173, the mold 140 substantially conforms to the shape of the upper portions 171 and 173 of the first and second members 162 and 164. By conforming to the shape of the upper portions 171 and 173 of the first and second members 162 and 164, the folded portions of the mold 140 advantageously help support the mold walls 142 during the molding process.

Referring again to FIG. 8, the lip segments 178b, 178c, 180b and 180c have apertures 188. In the illustrated embodiment, the apertures 188 are the same as, or similar to, the apertures 88 discussed above and shown in FIG. 5. Alternatively, the apertures 188 can be different from the apertures 88. Insertion of a mold (not shown) into the mold carrier 154 forms a mold assembly 138 as shown in FIG. 9.

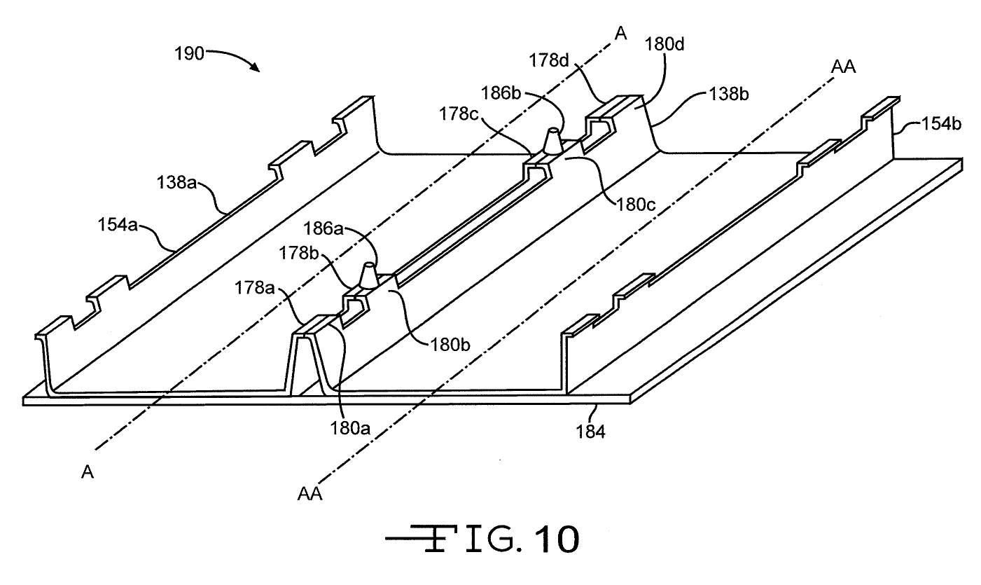

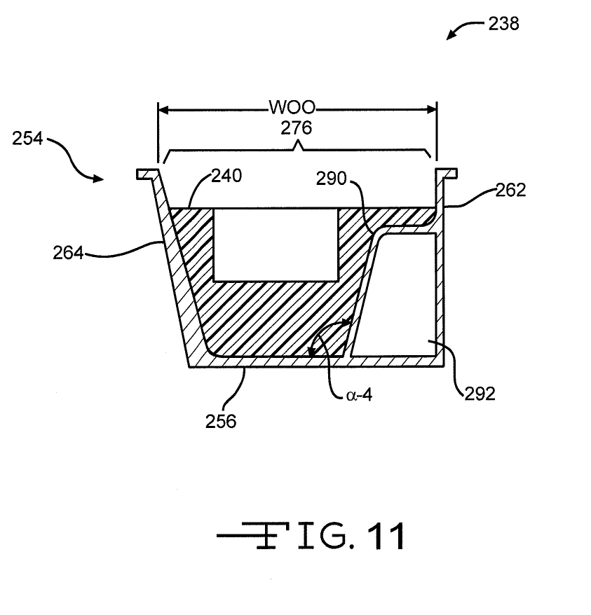

Referring now to FIG. 10, a pair of mold assemblies 138a and 138b (for purposes of clarity the molds are not shown), are positioned on a mold assembly platform 184. In the illustrated embodiment, the mold assembly platform 184 is the same as, or similar to, the mold assembly platform 84 described above and illustrated in FIG. 6. However, in other embodiments, the mold assembly platform 184 can be different from the mold assembly platform 84. Attaching the mold assemblies 138a and 138b to the mold assembly platform 184 forms production assembly 190.

The mold assemblies 138a and 138b are positioned on the mold assembly platform 184 such that the discontinuous lips 178a, 178b, 178c and 178d of mold carrier 154a align with the discontinuous lips 180a, 180b, 180c and 180d of mold carrier 154b. Arranging the mold assemblies 138a and 138b in this position, longitudinal axis A of mold carrier 154a and longitudinal axis AA of mold carrier 154b are substantially parallel to each other. The mold carriers 138a and 138b can be fastened to the mold assembly platform 184 as discussed above.

Optionally, in a similar manner as discussed above, locating pins 186a and 186b can be fastened to the intersection of the discontinuous lips 178b and 180b, and to the intersection of the discontinuous lips 178c and 180c. In the illustrated embodiment, the locating pins 186a and 186b are the same as, or similar to the locating pins 86a and 86b discussed above and illustrated in FIG. 6. However, the locating pins 186a and 186b can be different from the locating pins 86a and 86b.

In another embodiment of a mold carrier 254 as shown in FIG. 11, the mold carrier 254 includes a base member 256, a first member 262 and a second member 264. The base member 256, first member 262 and second member 264 can be the same as the base member 56, first member 62 and second member 64 described above and illustrated in FIG. 3. Alternatively, the base member 256, first member 262 and second member 264 can be different from the base member 56, first member 62 and second member 64. The mold carrier 254 further includes a third member 290 extending from the first member 262 to the base member 256. The third member 290 is configured to form a pocket 292. As shown in FIG. 11, the third member 290 cooperates with the base member 256 and the second member 264 to provide support for the mold 240. The mold carrier 254 has an opening 276 having a width WOO. In the illustrated embodiment, the opening 276 and the width WOO are the same as, or similar to, the opening 76 and the width WO of the mold carrier 54 discussed above and illustrated in FIG. 3. By having a similar opening 276 and a similar width WOO, the mold carrier 254 can be stacked with the mold carrier 54 discussed above and illustrated in FIG. 3, yet the mold carrier 254 can support molds 240 for forming masonry siding products having smaller dimensions than the masonry siding products formed by the mold 40 discussed above.

While the third member 290 of the mold carrier 254 illustrated in FIG. 11 is shown as forming an angle α-4 with the base member 256, it should be appreciated that the angle α-4 can be any desired angle, including the non-limiting example of a 90° angle. Insertion of the mold 240 into the mold carrier 254 forms mold assembly 238.

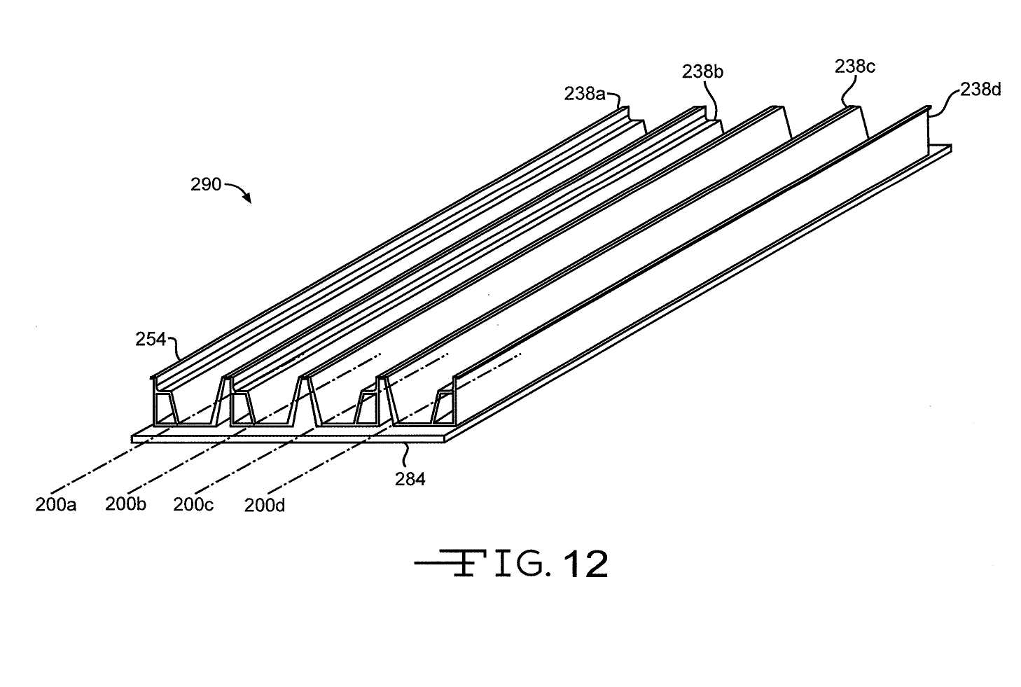

Referring now to FIG. 12, a plurality of mold assemblies 238a-238d (for purposes of clarity the molds are not shown), are positioned on a mold assembly platform 284. In the illustrated embodiment, the mold assembly platform 284 is the same as, or similar to, the mold assembly platform 84 described above and illustrated in FIG. 6. However, in other embodiments, the mold assembly platform 284 can be different from the mold assembly platform 84. Attaching the plurality of mold assemblies 238a-238d to the mold assembly platform 284 forms production assembly 290.

The mold assemblies 238a-238d are positioned on the mold assembly platform 284 such that longitudinal axes 200a, 200b, 200c and 200d of the mold assemblies 238a-238d are substantially parallel to each other. The mold assemblies 238a-238d can be fastened to the mold assembly platform 284 as discussed above.

While the embodiment of the production assembly illustrated in FIG. 12 shows a quantity of four mold assemblies 238a-238d, it should be appreciated that in other embodiments, more or less than a quantity of four mold assemblies 238-238d can be used.

Optionally, in a similar manner to the mold carriers 154a and 154b shown in FIG. 10, the mold carriers 254 can include notches (not shown) configured to allow the mold to “fold” over the upper portions of the first and second members.

The foregoing description of the various embodiments of the present invention has been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed is:

1. An apparatus configured to form masonry siding products, the apparatus comprising:
a mold having a mold bottom and a plurality of mold walls, the mold bottom and the mold walls defining a mold cavity; and
a mold carrier configured to support the mold bottom and the mold walls, the mold carrier having a first member extending upwardly from a base member and a second member extending upwardly from the base member;
wherein the first member forms an internal first angle with the base member, the first angle being at least 90°;
wherein the second member forms an internal second angle with the base member, the second angle being at least 90°;
wherein the internal first angle formed by the first member and the base member and the internal second angle formed by the second member and the base member are configured to allow for easy removal of the mold from the mold carrier.

2. The apparatus of claim 1, wherein the mold bottom and the plurality of mold walls are configured to flex, thereby allowing removal of the masonry siding products from the mold.

3. The apparatus of claim 1, wherein the base member, first member and second member each have a thickness in a range of from about 0.06 inches to about 1.5 inches.

4. The apparatus of claim 3, wherein the base member, first member and second member each have a thickness in a range of from about 0.10 inches to about 0.30 inches.

5. The apparatus of claim 1, wherein an intersection of the second member and the base member forms an arcuate cross-sectional shape having a radius in a range of from about 0.10 inches to about 0.50 inches.

6. The apparatus of claim 1, wherein the first member has a lip extending in a substantially horizontal direction away from the first member and the second member has a lip extending in a substantially horizontal direction away from the second member.

7. The apparatus of claim 1, wherein the base member, first member and second member form a unitary structure.

8. The apparatus of claim 7, wherein the mold carrier is made of an extrusion compatible material.

9. The apparatus of claim 6, wherein the lips extending from the first and second members have a plurality of apertures.

10. The apparatus of claim 1, wherein the mold carrier is open ended.

11. The apparatus of claim 1, wherein more than one mold carrier is mounted to a mold assembly platform such that longitudinal axes of the mold carriers are substantially parallel.

12. The apparatus of claim 6, wherein the lip extending from the first member of a mold carrier is aligned with the lip extending from the second member of a subsequent mold carrier.

13. The apparatus of claim 6, wherein the lips include apertures.

14. The apparatus of claim 13, wherein locating pins are fastened to the lips.

15. The apparatus of claim 14, wherein the locating pins have a frusto-conical cross-sectional shape.

16. The apparatus of claim 6, wherein the lips include notches.

17. The apparatus of claim 16, wherein the mold is configured to fold over the notches.

18. The apparatus of claim 2, wherein the flexible mold bottom and the flexible mold walls rely on the first and second members to define a mold cavity having a desired shape.

19. The apparatus of claim 1, wherein a third member extends from the first member to the base member, and wherein the third member is configured to form a pocket within the mold carrier.

20. The apparatus of claim 1, wherein at least one of the internal first and second angles is about 90°.

21. The apparatus of claim 20, wherein:
the internal first angle is about 90°; and
the internal second angle is in a range of from about 100° to about 110°.

22. A method of forming simulated stone corner products, the method comprising the steps of:
providing a mold having a flexible mold bottom and flexible mold walls;
positioning the mold within a mold carrier configured to support the flexible mold bottom and flexible mold walls, the mold carrier having a first member extending upwardly from a base member and a second member extending upwardly from the base member, wherein the first member, base member and second member form a unitary structure, and wherein the flexible mold walls rely on the first and second members to define a mold cavity having a desired shape;
filling the mold cavity with castable material;
allowing the castable material to harden thereby forming a simulated stone corner product;
removing the mold from the mold carrier; and
removing the simulated stone corner product from the mold by flexing the flexible mold walls.

23. The method of claim 22, including the step of allowing the flexible mold walls to fold over the first and second members.
